(19) United States
(12) Patent Application Publication
(10) Pub. No.: US 2019/0306639 A1
(43) Pub. Date: Oct. 3, 2019

(54) Apparatus for Controlling the Transmission of Communications Using a Proximity Sensor

(71) Applicant: Darren La Groe, Westlake Village, CA (US)

(72) Inventor: Darren La Groe, Westlake Village, CA (US)

(21) Appl. No.: 16/366,994

(22) Filed: Mar. 27, 2019

Related U.S. Application Data
(60) Provisional application No. 62/648,490, filed on Mar. 27, 2018.

(51) Int. Cl. H04R 27/00; H04M 1/60; H04M 9/00

(52) U.S. Cl. CPC H04R 27/00; H04M 2250/12; H04M 9/001; H04M 1/6041

(57) ABSTRACT

An apparatus provides efficient control for automatic and hands-free transmission of communications using the proximity of a user to a microphone of the apparatus. The apparatus comprises a controller, a proximity sensor used to determine the distance of the user from the microphone, an electronic relay controlled by the controller to engage the transmission, a push-to-talk button manual transmission, and a chassis to optimally contain the components thereof. At least one external communication device, such as a radio, connected to the electronic relay acquires an audio signal from a sound source. A speaker, either an external device or an integral part of the apparatus relays audio signals received by the radio back to the user. The controller then sends a signal to the electronic relay which connects and engages the radio or any other external communication device to enter the transmission mode.

The current application claims a priority to the U.S. Provisional Patent application Ser. No. 62/648,490 filed on Mar. 27, 2018.

### FIELD OF THE INVENTION

The present invention relates generally to the field of communication. More specifically, the present invention relates to an apparatus for engaging and disengaging the transmission function of a communication device using a proximity sensor or the like to trigger the transmitter thereof.

### BACKGROUND OF THE INVENTION

In a traditional environment where two-way radio communication is being used, a radio transmission is enabled by using a push-to-talk (PTT) button, also known as a key, located within or near the radio. When the button is pressed/activated, and the radio begins to transmit whatever signal (audio, data, or otherwise) is present at the microphone or any other communication device for input signal. This method usually requires a user to hold the microphone or other input device, or somehow physically interact with the radio to enable the transmission. For this reason, the system is not “hands-free” or automatic.

Several prior art systems have attempted to address one or more of these issues. For example, U.S. Pat. No. 9,118,768 to Qu describes a system that attempts to address this issue using a wristband that engages the push-to-talk function of a radio device when the wristband comes into a specified proximity of the device. The system “includes a user-wearable wrist band having a magnet to trigger a magnetic sensor located in the accessory when the wrist band is moved within close proximity to the magnetic sensor, thereby turning on the PTT function.” Although the Qu system provides the user with touchless operation of a radio's PTT transmission, it requires the user to wear an accessory in order to perform this function.

Another example, U.S. Pat. No. 8,095,081 to Vance, describes: “a device for hands-free push-to-talk functionality may include a push-to-talk sensor or push-to-talk button operable by at least one of a preset audible signal, a predetermined movement of the sensor or push-to-talk button, air pressure or the like. The device may also include means to control operation of a communications device in response to signals from the push-to-talk sensor or push-to-talk button.” This system uses the movement of a headset or other object to engage and disengage the transmission function of a two-way radio and audio present at the microphone. Although the Vance technology provides the user with a method of engaging the PTT transmission function of a radio without using a button, it does not allow for a hands-free operation and requires the user to reposition the device, a headset or otherwise, to activate the transmission function.

Automatic transmission can be accomplished using a technology known as “VOX” (Voice Operated Exchange, or Voice Operated Transmit). This is available in many radios. The VOX system senses the presence of audio signal. Once the audio signal reaches a certain level the system automatically enables the radio's transmission. This system works in situations where background noise is limited. VOX also often requires the user to hold the microphone in close proximity to the sound source (mouth or otherwise) to properly trigger the system. For this reason, VOX systems are not completely hands-free although a headset or tabletop microphone stand can enable hands-free operation. Additionally, VOX systems restrict the user to speaking only when the user wants the transmission to be activated. For this reason, the system limits the user to only radio related communication and prevents the user from having unrelated conversations or being in noisy environments. Although such systems offer a limited ability to provide the user with hands-free and/or automatic transmission, their ability to deal with all types of noise environments is limited.

The use of an external “foot-push-to-talk button” or other type of external push-to-talk button, has been used to allow for hands-free operation. This system requires the radio to have an external input to accommodate these devices and is not typically found on many existing radios. For this reason, users are limited to only using certain radios, purchasing accessories, or making complex modifications, to accomplish this.

It is an object of the present invention to provide a solution to the aforementioned problems and drawbacks. The present invention offers an automatic and hands-free transmission of communications between various communication devices such as microphones, speakers, radios, two-way radios, radio broadcasting devices, headphones, public address systems, intercom systems, walkie-talkies, etc. Further, the present invention comprises not only a stand-alone device that provides the automatic and hands-free transmission of communications, but also a versatile unit that can be incorporated to any communication devices and/or detachably attached thereof.

### SUMMARY OF THE TECHNOLOGY

An apparatus is provided for controlling automatic and hands-free transmission of communications using the proximity of a user to a microphone of the apparatus to engage the transmission. The apparatus comprises a controller such as a microprocessor used as the central controller, a proximity sensor used to determine the distance of the user from the microphone, an electronic relay controlled by the controller to engage the transmission function of the apparatus, a push-to-talk button to be used for manual transmission, and a chassis to optimally contain the components thereof. At least one external communication device, such as a microphone, acquires an audio signal from a sound source. A speaker, either an external device or an integral part of the apparatus relays audio signals received by the radio back to the user. The proximity sensor of the apparatus can sense the distance of a user (or other audio source) from the microphone, wherein the detection distance can be a user-defined or predetermined distance.

The apparatus can operate like a push-to-talk button or key, wherein the controller sends a signal to the electronic relay which connects and engages the radio or any other external communication device to enter the transmission mode. Further, the apparatus provides a push-to-talk button which can override the operation of the proximity sensor and offers the user a physical manual control which engages and disengages the transmission of the external communication devices.

### BRIEF DESCRIPTION OF THE DRAWINGS

FIG. 1 is an isometric perspective view of the preferred embodiment of the present invention.

FIG. 2 is a bottom view of the preferred embodiment of the present invention.

FIG. 3 is a rear view of the preferred embodiment of the present invention.

FIG. 4 is an exploded front view of the preferred embodiment of the present invention.

FIG. 5 is an exploded bottom view of the preferred embodiment of the present invention.

FIG. 6 is a top view of the preferred embodiment without the chassis of the present invention.

FIG. 7 is a bottom view of the preferred embodiment without the chassis of the present invention.

FIG. 8 is a rear view of the preferred embodiment without the chassis of the present invention.

FIG. 9 is an isometric perspective view of an alternative embodiment of the present invention.

FIG. 10 is an electrical diagram of the present invention.

### DETAIL DESCRIPTIONS OF THE INVENTION

All illustrations of the drawings are for the purpose of describing selected versions of the present invention and are not intended to limit the scope of the present invention.

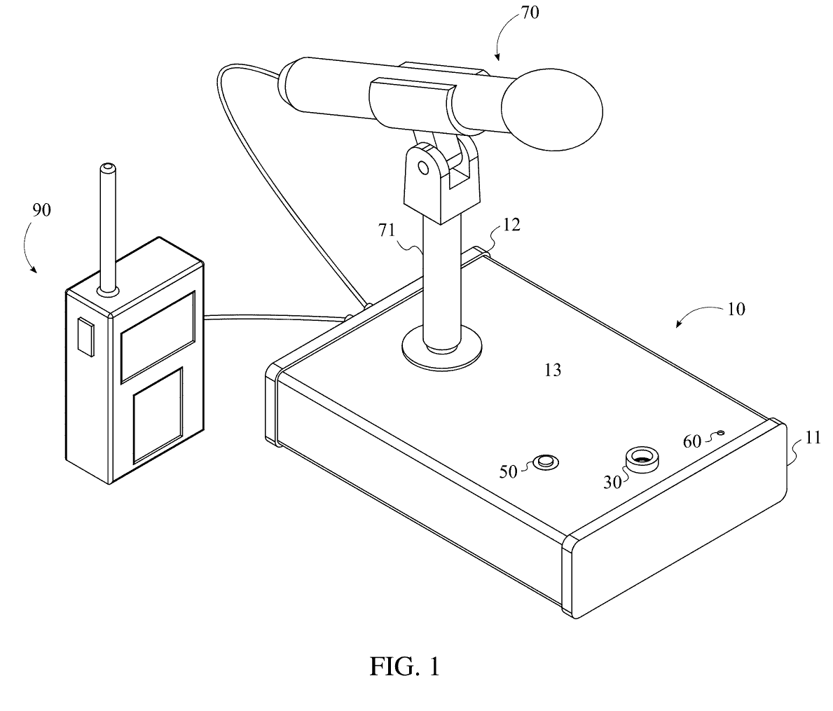

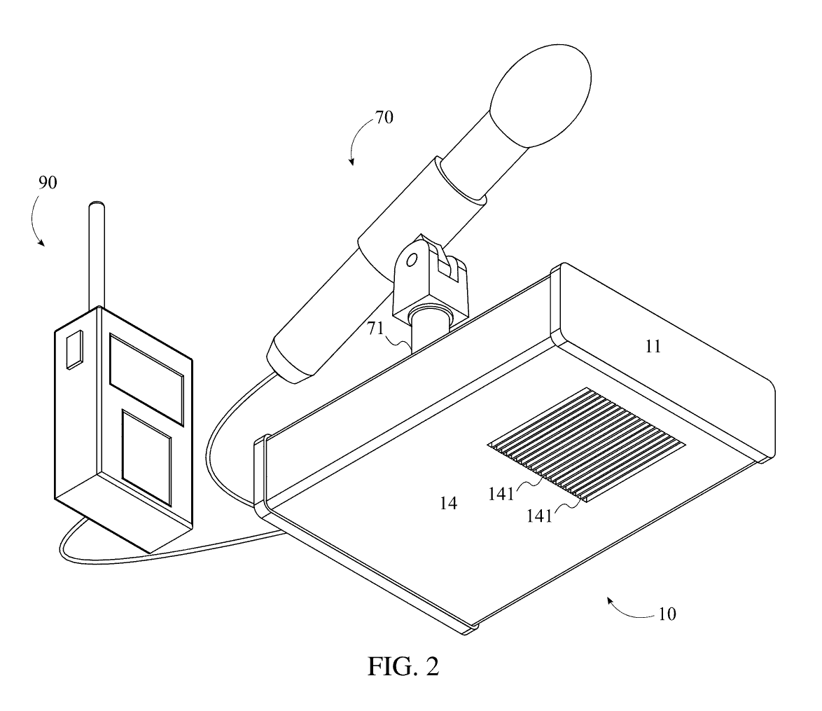

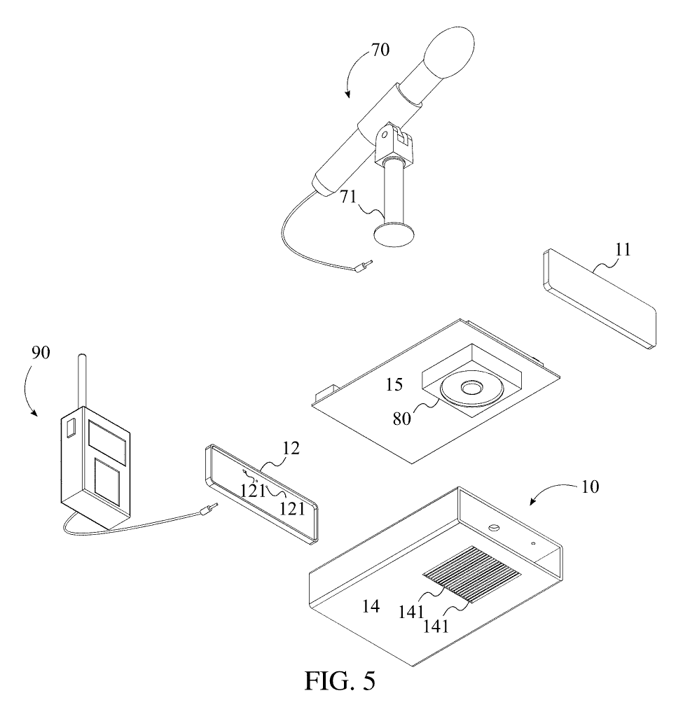

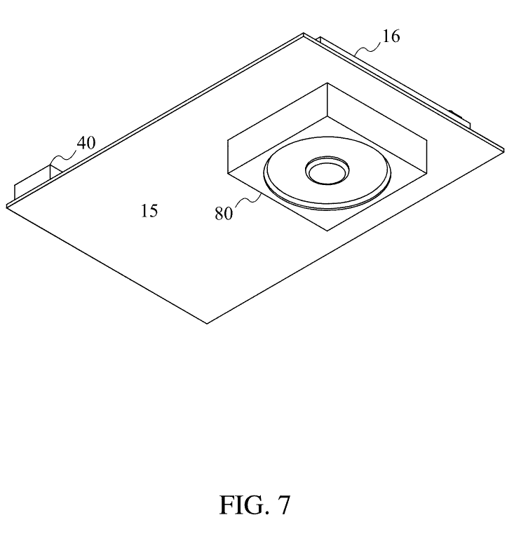

As can be seen in FIG. 1 to FIG. 10, the present invention comprises an apparatus that offers an automatic and hands-free transmission of communications between various communication devices such as microphones, speakers, radios, two-way radios, radio broadcasting devices, headphones, public address systems, intercom systems, walkie-talkies, etc. Additionally, the present invention comprises a stand-alone portable device that can be easily connected to any communication device to provide the automatic and hands-free transmission of communications. Further, the present invention is a versatile unit that can be integrated into and/or detachably attached to any communication device.

As can be seen in FIG. 1 to FIG. 8, in the preferred embodiment of the present invention, the present invention comprises a stand-alone, portable apparatus for controlling the transmission of communications between various external communication devices. The apparatus of the preferred embodiment of the present invention comprises a chassis 10, a controller, 20, a proximity sensor 30, an electronic relay 40, and at least one external communication device 90. More specifically, the chassis 10 is a durable and rigid enclosure that houses all necessary components of the present invention. The chassis 10 can be made of materials including, but not limited to, steel, stainless steel, galvanized steel, rigid plastics, composite materials, wood, ceramics, or any combinations of the materials thereof, etc. Additionally, the chassis 10 can be of any shape including, but not limited to, square, rectangular, diamond, oval, round, etc. Further, the chassis 10 provides rigid support to the apparatus of the present invention that connects to the at least one external communication device 90 including, but not limited to, a microphone, but may not be required if the present invention is installed or integrated onto a microphone directly.

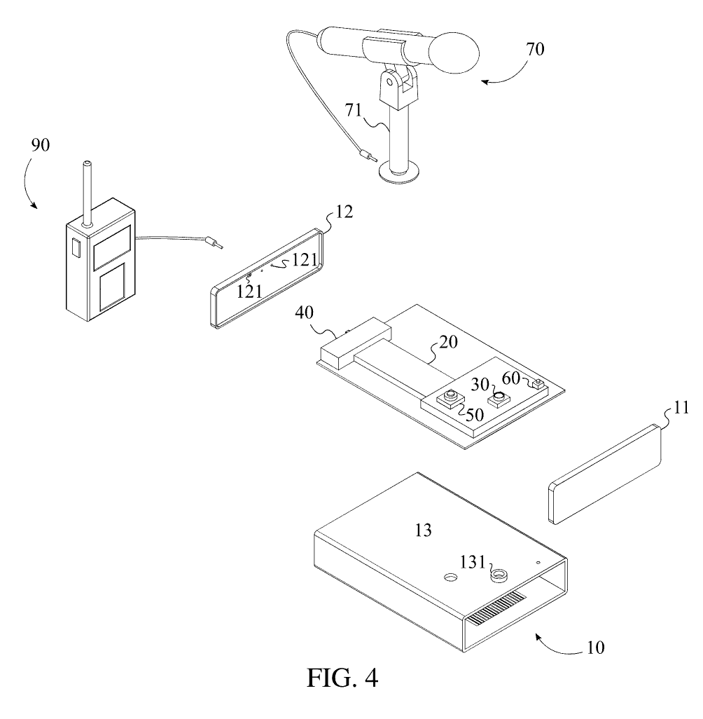

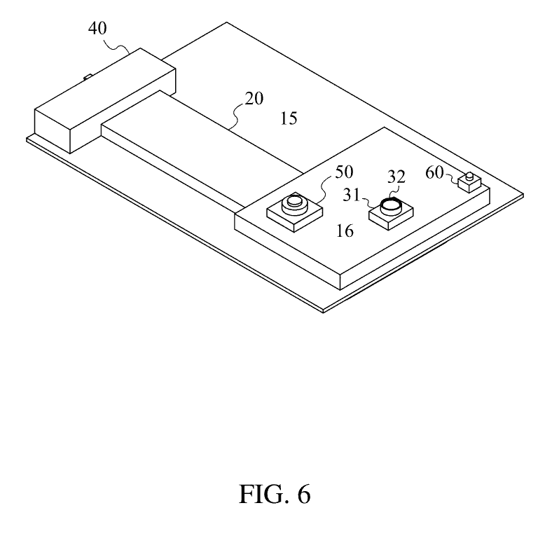

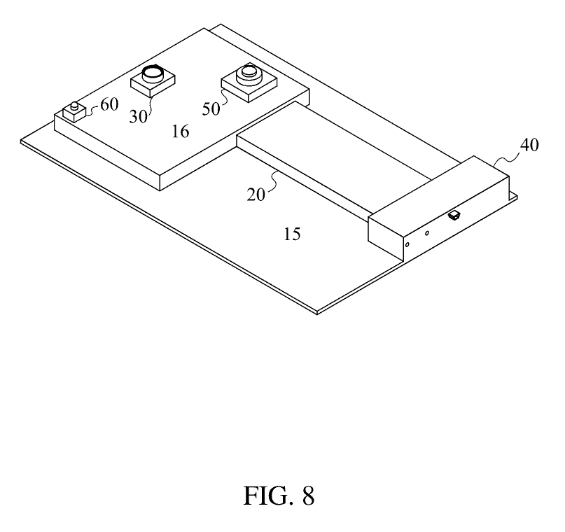

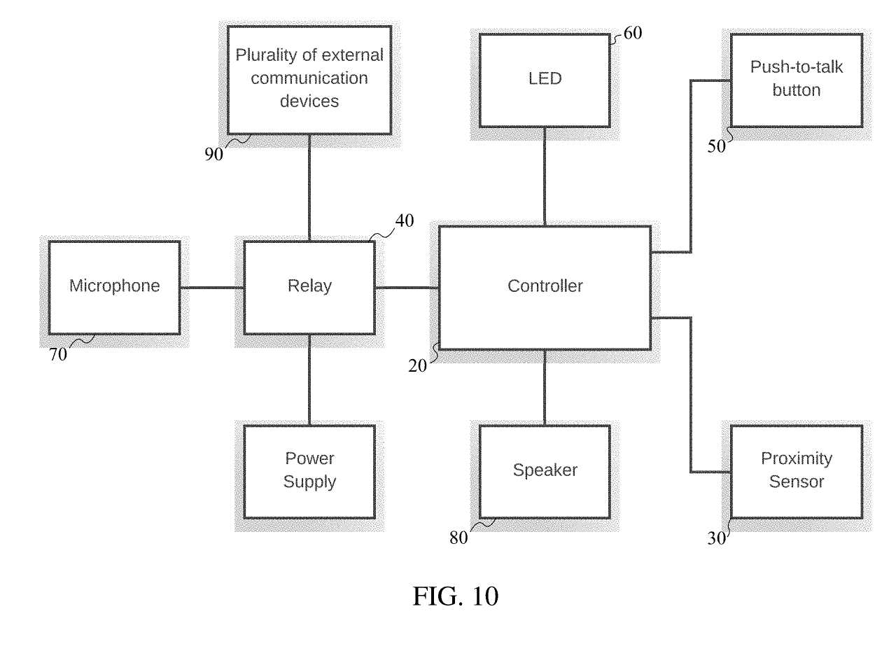

As can be seen in FIG. 4, FIG. 6, FIG. 8, and FIG. 10, the controller 20 and electronic relay 40 are interiorly positioned on the chassis 10. The proximity sensor 30 is mounted on the chassis 10. The proximity sensor 30 and electronic relay 40 are electrically connected to the controller 20, as seen in FIG. 10. The controller 20 can include, but is not limited to, a microcontroller, a microprocessor, a CPU (computer processing unit) controller, an Arduino “Uno”, “Nano”, or any similar controller development board with various inputs and outputs, or any other suitable controller. An important aspect of the controller 20 is the ability to control the data and/or signals received from various sources and sent to various destinations. Additionally, the controller 20 provides the central control of the present invention, wherein the controller 20 receives signals from the proximity sensor 30, controls the transmission of communication among various communication devices through the electronic relay 40.

The electronic relay 40 is connected to the at least one external communication device 90, which includes, but is not limited to, microphone, speaker, radio, two-way radio, radio broadcasting device, headphone, public address system, intercom system, walkie-talkie, etc. Controlled by the controller 20, the electronic relay 40 provides transmission connections for the at least one external communication device 90 for the user. The electronic relay 40 acts like a push-to-talk button by connecting the electrical components necessary for engaging the PPT communication function of the present invention. This enables the at least one external communication device 90 to transmit.

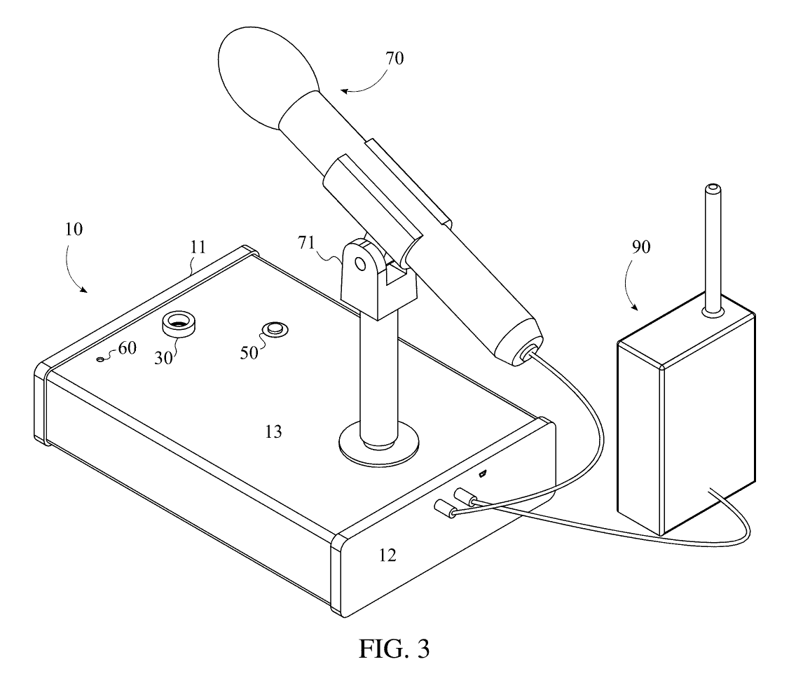

As can be seen in FIG. 1, FIG. 3 to FIG. 4, FIG. 6, and FIG. 8, the proximity sensor 30 can be interiorly or exteriorly mounted on the chassis 10. When the proximity sensor 30 is interiorly mounted on the chassis 10, the proximity sensor 30 is exposed, thus, the proximity sensor 30 can function efficiently for sensing the user in the proximity of the apparatus of the present invention and provides the desired transmission of communication. Specifically, as seen in FIG. 3 to FIG. 4, the proximity sensor 30 can comprise, but is not limited to, a HC-SE04 sensor, a PING sensor, a camera, a web-camera, an optical sensor, an ultrasonic sensor, and any other suitable sensor for sensing the user in the proximity of the apparatus of the present invention. An important aspect of the proximity sensor 30 is the ability to accurately detect the presence of an object within a specified distance. This desired distance can be set by the user or can be predetermined in the programming of the control software of the present invention. This is an integral part of the source code controlling the controller 20.

As can be seen in FIG. 4 to FIG. 6, the chassis 10 comprises a front 11, back 12, a first side 13, a second side 14, a mounting plate 15, and a sensor mount 16. The back 12 comprises a plurality of cable holes 121, which is used to provide access for any cable of the at least one external communication device 90 to be connected to the electronic relay 40. The first side 13 comprises a sensor hole 131 that provides exposure of the proximity sensor 30 when mounted on the interior of the chassis 10. Additionally, the second side 14 comprises a plurality of slots 141. Further, the second side 14 provides solid support and base on which the mounting plate 15 is mounted such that the mounting plate 15 is positioned within the interior of the chassis 10. Both the controller 20 and electronic relay 40 are mounted on the mounting plate 15, adjacent to each other. The sensor mount 16 is mounted to the mounting plate 15 adjacent to the controller 20, opposite the electronic relay 40. Further, the proximity sensor 30 is mounted on the sensor mount 16. The proximity sensor 30 comprises a body 31 and a head 32, as seen in FIG. 6. The head 32 is centrally and terminally positioned on the body 31. Additionally, the body 31 is mounted to the sensor mount 16, and the head 32 is concentrically positioned within the sensor hole 131 of the first side 13 of the chassis 10, thus, proximity sensor 30 is exposed through the chassis 10 for efficient detection of any object with the prespecified distance of the proximity sensor 30 and send accurate detection signal to the controller 20 for the transmission of communication through the apparatus of the present invention.

As can be seen in FIG. 1 to FIG. 8, and FIG. 10, in another embodiment of the present invention, the apparatus comprises a push-to-talk button 50, a light-emitting diode (LED) 60, a microphone 70, and a speaker 80. The microphone 70 comprises a stand 71, which provides support for the microphone 70. The stand 71 is mounted to the chassis 10 through the first side 13, adjacent to the back 12. The microphone 70 is positioned adjacent to the proximity sensor 30 and electrically connected to the electronic relay 40. Further, the microphone 70 is controlled by the controller 20 to capture the audio signal of the sound source, which is then broadcasted when the at least one external communication device 90 is a radio and the transmission is engaged. An important aspect of the microphone 70 is its location relative to the proximity sensor 30. By placing the microphone 70 in a distance near the proximity sensor 30, but not obstructing the proximity sensor 30, the microphone 70 is able to pick up the user's voice (or other sounds) without triggering the proximity sensor 30 itself. The push-to-talk button 50 is exteriorly mounted to the first side 13, adjacent to the proximity sensor 30. Additionally, the LED 60 exteriorly is mounted to the first side 13, adjacent to the proximity sensor 30 but opposite the push-to-talk button 50. Both the push-to-talk button 50 and LED 60 are electrically connected to the controller, as seen in FIG. 10. The controller 20 sends signals to the electronic relay 40 and the LED 60 when triggered by either the proximity sensor 30 or the push-to-talk button 50. Typically, the controller 20 activates the proximity sensor 30 to constantly send measurement data back to the controller 20. This can be used to enable other related functionality such as a warning signal when an object has moved outside the specified range to enable transmission. When an object including, but not limited to, a human head or other sound source, etc., moves within the specified distance, the controller 20 receives this data and triggers the electronic relay 40 to engage, thereby activating the transmission function of the at least one external communication device 90 such as a radio. Further, the push-to-talk button 50 allows the user to manually trigger the apparatus. The push-to-talk button 50 can override the proximity sensor 30 in order to engage the transmission when either the proximity sensor 30 is not working as expected or the user is out of range and requires the apparatus to be activated. Additionally, the push-to-talk button 50 can include, but is not limited to, any latching or non-latching hardware button, or any suitable push-to-talk button that sends an appropriate voltage to the digital input of the controller 20, which can react to a low voltage charge sent from the push-to-talk button 50.

The LED 60 signals the user that either the proximity sensor 30 is detecting an object within the specified range, and/or that the electronic relay 40 has engaged, and thus, has enabled the at least one external communication device 90 to begin transmitting.

The speaker 80 is mounted to the mounting plate 15, opposite the sensor mount 16 and adjacent to the front 11. Additionally, the speaker 80 is oriented parallel with and position adjacent the plurality of slots 141 of the second side 14 of the chassis 10. Further, the speaker 80 is electrically connected to the electronic relay 40 and controlled by the controller 20 to relay audio signals received by the at least one external communication device 90 back to the user.

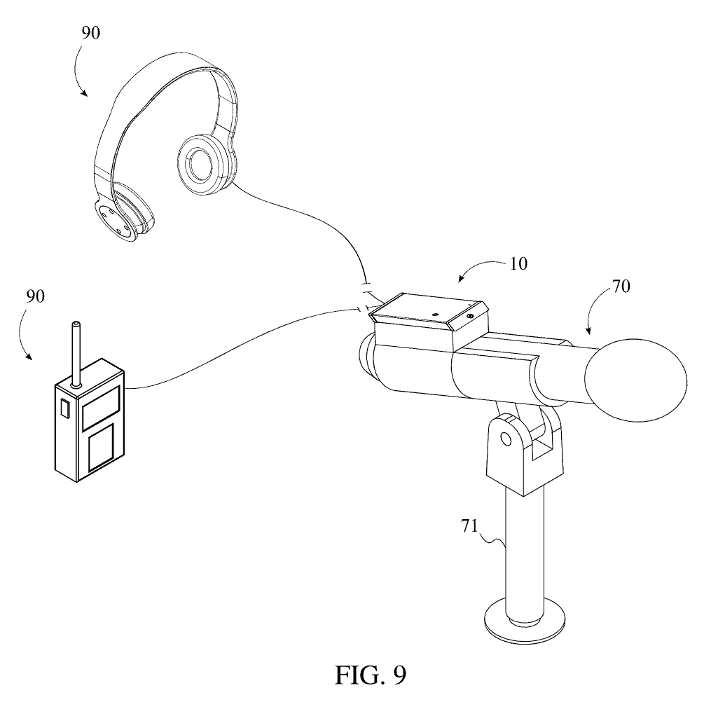

As can be seen in FIG. 9, in an alternative embodiment of the present invention, the apparatus of the present invention comprises a versatile unit that can be integrated into and/or detachably attached to any communication device. In this embodiment, the present invention comprises the at least one external communication device 90 and the microphone 70. The at least one external communication device 90 includes, but is not limited to, a headphone, a radio, and/or any other communication device. The microphone 70 is detachably attached to a stand 71. The chassis 10 of the apparatus of the present invention is positioned on the microphone 90. Additionally, the present invention is electrically connected to the microphone 70 and the at least one external communication device 90. In this embodiment as seen in FIG. 9, the present invention is connected to a headphone and a radio.

A suitable direct current (DC) power supply, as seen in FIG. 10, is needed to supply power to the controller 20 and other components of the apparatus that require power. The power supply can be an alternate current (AC) to DC transformer, a battery, or any other suitable device capable of providing the required power to operate the apparatus of the present invention.

In some embodiments the controller 20 used is any controller 20 capable of completing the functions necessary to enable the present invention. In some embodiments no controller 20 is used, and the apparatus is controlled with basic mechanical elements capable of performing the same functions. In some embodiments the proximity sensor 30 used is ultrasonic and uses ultra-high-frequency sound to determine the distance of an object. In some embodiments the proximity sensor 30 used is optical and uses infrared or other light to determine the distance of an object. In some embodiments the controller 20 is omitted and the proximity sensor 30 manually trigger the electronic relay 40 which engages the transmission of the at least one external communication device 90.

In some embodiments, the two dedicated leads of the at least one external communication device 90 including, but not limited to, a radio, may be shorted to enable the transmission function of the present invention. In other embodiments, shorting the ground lead and one of the dedicated leads of the at least one external communication device 90 including, but not limited to, a microphone, a speaker, etc., can activate the transmission function of the present invention. In yet other embodiments, entirely connecting and disconnecting the ground lead of the at least one external communication device 90 can control the transmission function of the present invention. In some embodiments, the push-to-talk button can be an external foot switch.

In some embodiments the electronic relay 40 is omitted, and the transmission of the at least one external communication device 90 is engaged through a different component. In some embodiments the push-to-talk button 50 is omitted allowing the apparatus to be controlled with only the proximity sensor 30. In some embodiments multiple proximity sensors 30 are used to determine the distance of an object. In some embodiments the microphone 70 is used to sense the ultrasonic pulses and acts as both a proximity sensor 30 and the microphone 70. In some embodiments the proximity sensor 30 sensors microphone 70 is used to transmit audio to the at least one external communication device 90. In some embodiments both the proximity sensor 30 and other sound detection devices, such as VOX, are used to engage the transmission of the apparatus.

The present invention can comprise source code used to program the apparatus. The source code implements the logic applied to the operation of the apparatus of the present invention. The source code can use any suitable computer programming language including, but not limited to, C programming language.

In some embodiments the source code is in a different programming language. In some embodiments the source code uses different logic. In some embodiments this technology is used to operate a telephone, intercom, cellular, mobile, or other external communication device 90. In some embodiments, headphones may be used instead of a speaker 80. In some embodiments a headset containing both a microphone and a speaker may be used. In some embodiments some or all of the components of the present invention are contained within a radio. In some embodiments some or all of the components of the present invention are contained within a microphone, speaker, headset, or other apparatus. In some embodiments the proximity sensor 30 has a push-to-talk button 50 to enable and disable its functionality. In some embodiments a recording device may be integrated into the apparatus. In some embodiments a distribution system such as a public-address system or other similar system may be integrated. In some embodiments the apparatus may be incorporated into a sterile environment since it does not require the user to touch the apparatus.

Although the invention has been explained in relation to its preferred embodiment, it is to be understood that many other possible modifications and variations can be made without departing from the spirit and scope of the invention as hereinafter claimed.

What is claimed is:

1. An apparatus for controlling the transmission of communications comprising:
a chassis;
a controller;
a proximity sensor;
an electronic relay;
the controller and electronic relay being interiorly positioned on the chassis;
the proximity sensor being mounted on the chassis; and
the proximity sensor and electronic relay being electrically connected to the controller.

2. The apparatus for controlling the transmission of communications as claimed in claim 1 where the proximity sensor being exteriorly mounted on the chassis.

3. The apparatus for controlling the transmission of communications as claimed in claim 1 comprising:
the chassis comprising a hole;
the proximity sensor comprising a body and a head;
the body of the proximity sensor being interiorly mounted on the chassis;
the head being centrally and terminally positioned on the body;
the head of the proximity sensor being concentrically positioned within the hole of the chassis.

4. The apparatus for controlling the transmission of communications as claimed in claim 1 comprising:
at least one exterior communication device; and
the at least one exterior communication device being electrically connected to the electronic relay.

5. The apparatus for controlling the transmission of communications as claimed in claim 1 comprising:
a push-to-talk button;
an LED (light emitting diode);
a microphone;
a speaker;
the chassis comprising a front, a back, a first side, a second side, a mounting plate, and a sensor mount;
the back comprising a plurality of cable holes;
the first side comprising a sensor hole;
the second side comprising a plurality of slots;
the plurality of slots being distributed across the second side adjacent the front;
the mounting plate being mounted to the second side;
the speaker being mounted to the mounting plate adjacent the plurality of slots of the second side;
the electronic relay being mounted to the mounting plate adjacent the back;
the speaker being electrically connected to the electronic relay;
the controller being mounted to the mounting plate adjacent the electronic relay;
the sensor mount being mounted to the mounting place adjacent the controller;
the sensor mount being positioned opposite the speaker;
the proximity sensor being mounted to the sensor mount;
the push-to-talk button being mounted to the sensor mount adjacent the proximity sensor;
the LED being mounted to the sensor mount adjacent the proximity sensor;
the push-to-talk button and LED being electrically connected to the controller;
the microphone comprising a stand;
the stand being mounted to the first side of the chassis;
the microphone being mounted to and supported by the chassis through the stand; and
the microphone being electrically connected to the electronic relay;

6. The apparatus for controlling the transmission of communications as claimed in claim 1, wherein the controller being a microcontroller.

7. The apparatus for controlling the transmission of communications as claimed in claim 1, wherein the proximity sensor being a camera.

8. The apparatus for controlling the transmission of communications as claimed in claim 1, wherein the proximity sensor being a web-camera.

9. The apparatus for controlling the transmission of communications as claimed in claim 1, wherein the proximity sensor being an optical sensor.

10. The apparatus for controlling the transmission of communications as claimed in claim 1, wherein the proximity sensor being an ultrasonic sensor.

11. An apparatus for controlling the transmission of communications comprising:
a chassis;
a controller;
a proximity sensor;
an electronic relay;
at least one exterior communication device;
the controller and electronic relay being interiorly positioned on the chassis;
the proximity sensor being mounted on the chassis;
the electronic relay being electrically connected to at least one exterior communication device; and
the proximity sensor and electronic relay being electrically connected to the controller; and
the electronic relay being electrically connected to at least one exterior communication device.

12. An apparatus for controlling the transmission of communications comprising:
a chassis;
a controller;
a proximity sensor;
an electronic relay;
at least one exterior communication device;
the chassis being positioned on the at least one exterior communication device;
the controller and electronic relay being interiorly positioned on the chassis;
the proximity sensor being mounted on the chassis;
the proximity sensor and electronic relay being electrically connected to the controller; and
the electronic relay being electrically connected to at least one exterior communication device.

13. The apparatus for controlling the transmission of communications as claimed in claim 12, where the at least one exterior device comprising a microphone.

14. The apparatus for controlling the transmission of communications as claimed in claim 12, where the at least one exterior device comprising a headphone.

15. The apparatus for controlling the transmission of communications as claimed in claim 12, where the at least one exterior device comprising a speaker.

16. The apparatus for controlling the transmission of communications as claimed in claim 12, where the at least one exterior device comprising a radio broadcasting device.

17. The apparatus for controlling the transmission of communications as claimed in claim 12, where the at least one exterior device comprising a public address system.

18. The apparatus for controlling the transmission of communications as claimed in claim 12, where the at least one exterior device comprising an intercom system.
